(19) United States
(12) Patent Application Publication
(10) Pub. No.: US 2006/0238802 A1
(43) Pub. Date: Oct. 26, 2006

(54) System and method for providing enterprise wide data security

(76) Inventors: John W. Hanay, Palo Alto, CA (US); Justin P. Maksim, San Jose, CA (US); Cuong G. Williams, Herndon, VA (US); Yuri Yuryev, San Mateo, CA (US)

Correspondence Address: Douglas J. Rusch;Beachhead Solutions, Inc., Suite 850, 2350 Mission College Blvd., Santa Clara, CA, 95054, US

(21) Appl. No.: 11/408,214

(22) Filed: Apr. 19, 2006

Related U.S. Application Data
(60) Provisional application No. 60/673,625, filed on Apr. 20, 2005.

(51) Int. Cl. G06F 3/12

(52) U.S. Cl. 358/1.15

(57) ABSTRACT

A system of securing data stored on a portable electronic device and an associated method are disclosed. The system includes a server machine coupled to the portable electronic device, the server machine comprising a plurality of data sets adaptively coupled to a document map database, the document map database storing a document catalog provided by a document audit agent residing on the portable electronic device, the portable electronic device further comprising a rules agent operable to execute security rules associated with each of the plurality of data sets.

### CROSS REFERENCE TO RELATED APPLICATIONS

The present application claims priority under 35 U.S.C. 119(e) from provisional patent application Ser. No. 60/673,625, entitled “Enterprise Wide Lost Data Destruction”, filed on Apr. 20, 2005, the disclosure of which is herein incorporated by reference in its entirety. The present application is also related to patent application Ser. No. 10/897,964 entitled “A System and Method For Lost Data Destruction of Electronic Data Stored on Portable Electronic Devices”, patent application Ser. No. 10/897,306 entitled “A System and Method For Lost Data Destruction of Electronic Data Stored on a Portable Electronic Device Using a Security Interval, and patent application Ser. No. 10/897,307 entitled “A System and Method For Lost Data Destruction of Electronic Data Stored on a Portable Electronic Device Which Communicates with Servers That are Inside of and Outside of a Firewall”, the disclosures of which are herein incorporated by reference in their entireties.

### BACKGROUND OF THE INVENTION

1. Field of the Invention

The present invention relates to data security and access control of networked computing devices. More specifically, the present invention relates to networks of computing systems and remote management of stored data to map files stored on remote computing devices to thereby enable knowledge of all documents stored on the remote devices, risk assessment, the destruction of critical files, and greater disclosure after theft or loss of the computing devices.

2. Description of Related Art

Electronic information is increasingly stored on computing devices and often on devices that are designed for portability and mobility. These devices allow for anytime, anywhere computing including telecommuting and work from home offices. As evidenced by the recent disclosure that a stolen laptop of a Fidelity Investments employee included the personal information of 196,000 current and former employees of Hewlett Packard, the electronic information stored on these computing devices is susceptible to misappropriation through loss, theft, or unauthorized use of the computing devices.

Commonly used access control methods including a combination of user identification and a password provide only limited protection and can be circumvented. Data encryption also does not provide security to stored data as encryption keys may be discovered by computer driven trial and error processes. Further, data erasure may leave vestiges of erased files on data storage devices and thus erasure of data may not conceal or protect information. After erasure or overwriting, sophisticated tools may detect variations in storage media that can be used to reconstruct the previously stored data.

To address these problems in data security, proposed data security legislation requires companies that collect and store sensitive customer data—such as social security numbers, drivers license details and financial information—to implement effective security safeguards, such as encryption technology. The proposed legislation further requires companies to notify customers if data security is breached and the information could be used for identity theft. It is therefore important that companies that collect and store sensitive customer data have direct knowledge of the data stored on enterprise computing devices.

Systems and methods developed by Beachhead Solutions, Inc. of Santa Clara, Calif. reduce or eliminate the risk of exposing sensitive electronic information to access by unauthorized users of compromised computing devices. These systems provide a plurality of methods for identifying a compromised computing device through the detection of loss, theft and attempted unauthorized access of the computing device and any sensitive information stored therein. Further, the systems protect an owner of sensitive information by providing methods for rapid, targeted destruction of the sensitive information stored on the compromised computing device thereby reducing the risk that data may be reconstructed after erasure by an unauthorized user of the compromised computing device.

The system may include a client, a central controller server and a communications link. The client and the central controller server are connected using the communications link. The client may be a computing device such as another server, a desktop computer, a notebook computer, a handheld computer, an electronic organizer, a personal data assistant, a cellular telephone, a multimedia entertainment system, a network router, a network switch or a network edge device. A rules agent may be embedded in the client or in a storage device connected to the client. The rules agent controls access to stored data independently of the central controller server, providing a plurality of services including encryption, lost data destruction, communications monitoring and system security monitoring.

The rules agent implements a set of security rules propagated by the central controller server. The security rules may direct the rules agent to organize stored information into a plurality of files, directories, sections and blocks based upon system file paths. The security rules may assign attributes to the files, directories, sections and blocks which, for example, determine prioritized security levels based on information type, information size, time sensitivity of the information, uniqueness of the information, and importance of the information. The security rules may also select processes associated with each file, directory, section and block wherein the processes include methods including encryption, destruction, user authentication and other processes used in the protection, handling and manipulation of the information.

The security rules may specify the indicia used to determine when the security of the computing device has been compromised. The security rules may determine the type and frequency of device monitoring performed by the rules agent and may describe combinations of events and system status that represent threats to the security of the stored information.

The security rules may establish actions and procedures initiated by the rules agent to monitor and protect the security of the stored information. The actions and procedures specified by the rules include methods to encrypt data and methods to erase data. The encryption and data erasure methods may be implemented using a combination of services and functions provided by components intrinsic and extrinsic to the client including components such as operating systems, storage devices, commercially available software and open-source software. Further, the security rules may include time-sensitive rules including rules that cause the deletion of selected data after the expiration of certain time periods.

The rules agent may initiate encryption automatically upon the client receiving a copy of the set of rules propagated by the central controller server. After the client successfully receives the rules, the rules agent reviews the encryption rules and verifies the encryption status of all files designated by the rules to be encrypted. Encryption may also be performed by the rules agent following the occurrence of certain system events such as power on, power off, intrusion detection, invalid login attempts and detection that the client has been lost or stolen.

The client communicates with the central controller server at selected, regular intervals using the communications link. Successful communication may comprise a transmittal of status information by the client and a transmittal of status and rules by the central controller server. After each successful communication between the central controller server and the client, the rules agent starts a first timer that measures the period of time that the communications link is inoperative. If the communications link is inoperative for a period greater than a selected “activation interval,” then the rules agent will determine that the client has been lost or stolen or otherwise compromised. Since the activation interval can elapse while the client is turned off, once the client is first turned on after the activation interval has elapsed or if on when the activation interval elapses, the rules agent then starts a second timer. The second timer measures a second time period during which the user may be periodically notified of the loss of communications with the central controller. If the second time period exceeds a selected “grace period,” then the rules agent will initiate programmed events, which may include the destruction of certain of the stored data. The user may reset the activation timer and the grace timer during the grace period by providing one or more identity authentications such as a password.

The activation interval is measured as an elapsed time that includes the time when the computing device is powered off or otherwise inoperable. The grace period measures only time during which the device is powered on and operational. When the grace period exceeds a selected maximum grace period, the rules agent determines that the stored data is lost, and proceeds to execute rules that will cause security enhancing events to automatically occur. If the grace period is selected as zero, then immediately after the elapsing of the activation interval, the rules agent will initiate the programmed events.

The rules agent may also determine that the stored data is lost in other ways including excessive invalid login attempts and by system administrator notification. The rules agent may monitor the computing device to detect indicators of attempts at unauthorized access such as invalid login attempts and security log entries. A system administrator may make an entry on the system controller server designating the stored data as lost. The designation may be made in the form of a lost/stolen status value transmitted to the rules agent and may be reflected in the security rules associated with the device. Upon receiving the status value, the rules agent initiates lost data actions.

When it is established that the stored data is lost after the elapsing of the grace period, the rules agent initiates a process (known hereinafter as “lost data destruction”) comprising a plurality of actions to erase the stored data. Lost data destruction may include a combination of processes including data erasure, prioritized data overwrite, selective encryption, destruction of stored encryption keys, destruction of rules, forced system shutdown and physical device disablement. The lost data destruction activity may be disguised by eliminating all external signs of system activity or by providing incorrect system status information.

These known systems and methods provide a data erasure method that significantly reduces the risk that erased data may be recovered by analysis of the physical, electrical and electromagnetic characteristics of the storage device. The method obliterates files by repetitively filling the file with randomly generated sets of data, using different randomly generated sets of data on each repetition. Files may be obliterated by filling the file once with a randomly generated set of data. The data erasure method removes or obscures vestigial impressions of previously stored data from storage devices.

The lost data destruction systems and methods of the prior art rely upon file system paths to identify and destroy data on a compromised computing device identified by the system. For example, if a computing device is determined to be compromised by the rules agent, the files stored in the My Documents directory may be targeted for destruction. Files created by a user and stored in other than conventional or standard locations create a significant problem in that system administrators do not have direct knowledge of all documents stored on devices across an enterprise. As such, administrators are not able to target specific documents for destruction. Furthermore, administrators are not able to determine the risk exposure associated with the theft or loss of compromised computing devices. Nor are administrators able to comply with compliance and disclosure requirements without knowledge of documents residing on the compromised computing devices.

### SUMMARY OF THE INVENTION

The current invention provides a system and method that gives system administrators direct knowledge of all documents residing on all devices across an entire enterprise. An enterprise wide document map allows system administrators to perform document auditing to select and tag files for destruction in the event of a loss or theft. The invention provides a means by which system administrators can manage documents rather than managing devices while at the same time enabling identification of documents on a compromised device to thereby provide improved risk assessment.

Document auditing provides systems administrators with knowledge of the status of all devices across the enterprise prior to a theft or loss. Upon the theft or loss of a device, the system and method of the invention provide for destruction of critical files with precision. The system and method of the invention further allow for greater disclosure of compromised data to authorities.

In accordance with one aspect of the invention, a system for providing enterprise wide data security includes a server machine having a document map database coupled to a plurality of data sets, and at least one client machine coupled to the server machine, the at least one client machine having stored thereon data to be secured, the at least one client machine comprising a rules agent and a document audit agent.

In accordance with another aspect of the invention, a system of securing data stored on a portable electronic device includes a server machine coupled to the portable electronic device, the server machine comprising a plurality of data sets adaptively coupled to a document map database, the document map database storing a document catalog provided by a document audit agent residing on the portable electronic device, the portable electronic device further comprising a rules agent operable to execute security rules associated with each of the plurality of data sets.

In accordance with yet another aspect of the invention, a method of securing data stored on a plurality of client machines includes the steps of gathering and updating document information in each of the plurality of client machines, communicating the document information to a server machine, populating and updating a document map database in the server machine, displaying a visual document map on the server machine, and creating and updating a plurality of data sets based upon the visual document map, the plurality of data sets having associated therewith security rules for securing the data stored on the plurality of client machines.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of functional components and to the arrangements of these components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block representation of a prior art system of lost data destruction;

FIG. 2 is a functional representation of a structure of the client in accordance with the invention;

FIG. 3 is a block representation of an exemplary embodiment of the invention; and

FIG. 4 is a flow chart of an exemplary embodiment of a method in accordance with the invention.

### DETAILED DESCRIPTION OF A PREFERRED EMBODIMENT OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the components referred to herein by way of illustration.

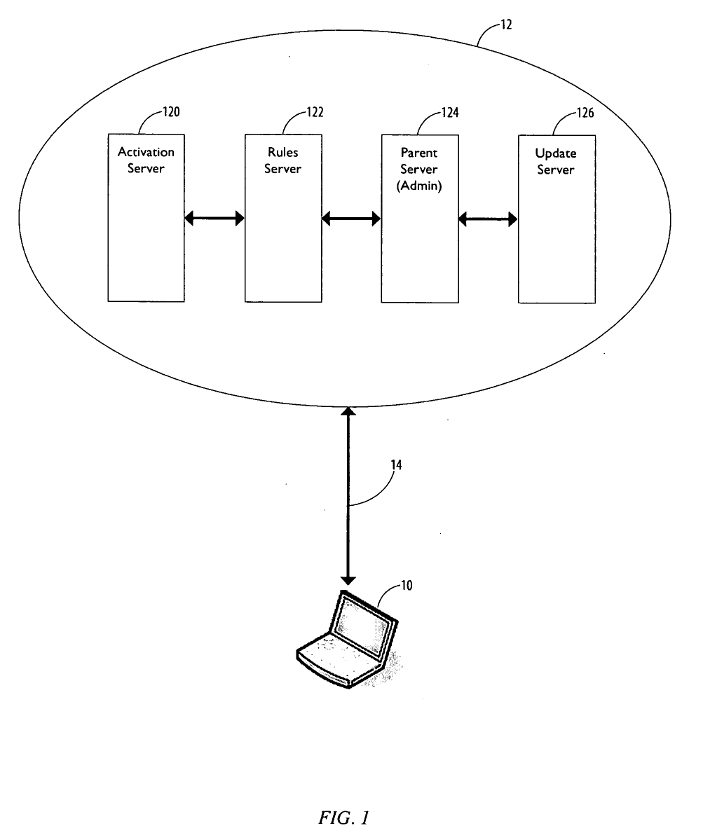

FIG. 1 shows an architecture within which the present invention may be practiced. The architecture comprises a client 10 and a central controller server 12 including an activation server 120, a rules server 122, a parent server 124 and an update server 126. These various identifications of server 12 as including servers 120-126 are provided solely for purposes of discussion, and it is understood that unless described otherwise hereinafter with respect to specific embodiments, a single physical server, or various different physical servers, can be used to implement the different functionalities described herein with respect to each server 120-126, and that not all of the functionalities of each of the different servers 120-126 are needed to implement various different aspects of the present invention. As a primary focus of the present invention is the security of electronic data stored on the client 10, the type of server 12, including its various different hardware and software components, as well as the configuration of server(s), is not of particular significance, and as such many different combinations of hardware and software components can be used to implement the central controller server. Operation of the activation server 120, the rules server 122, the parent server 124, and the update server 126 are described in the co-pending applications referred to in the Cross Reference to Related Applications section of this application.

The client 10 may be a computing device such as a desktop computer, a server, a notebook computer, a handheld computer, a Personal Data Assistant (PDA), a network router, a cellular telephone, multimedia entertainment system, network router, network switch, network edge device or any other device that is capable of storing data. A common aspect of the different types of client 10 referred to above is that each client 10 will include a processor of some type that is capable of executing an operating system of some type, and applications thereon, and that electronic data is stored in memory of some type. In the exemplary embodiment, the client 10 is a notebook computer upon which a Microsoft® Windows XP Professional operating system 220 is installed, and, as such, familiarity with the features of this operating system, including Encrypting File System (EFS), is assumed. Further, the operating system runs with a compatible processor, such as an Intel® processor. Notwithstanding the above, other operating systems, such as Linux, Solaris, Palm OS or Pocket PC, only by way of example, and processors, such as manufactured by AMD, MIPS, Tensilica, ARM, or Transmeta, only by way of example, can be used with the present invention. It will be apparent that less powerful devices 10 will typically have simpler processors, operating systems, and features, and as such less powerful devices 10 may not be able to implement all the features described herein.

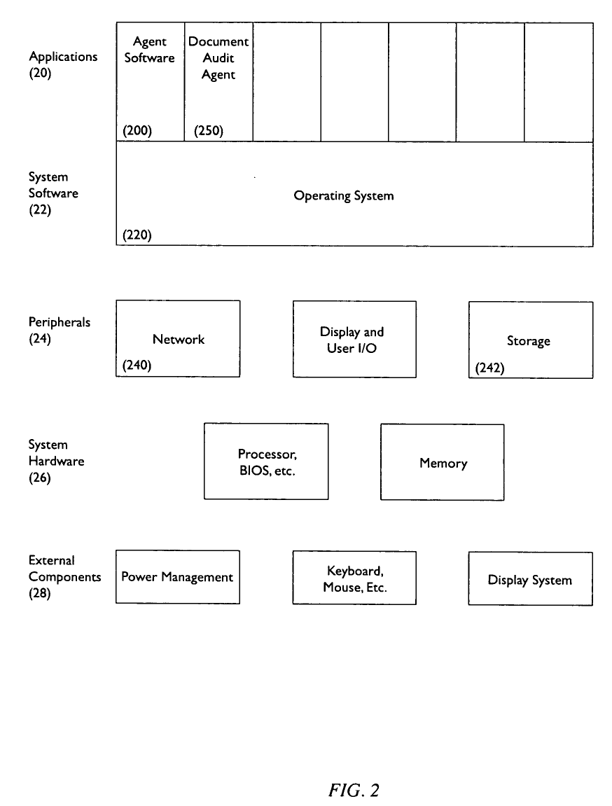

As illustrated in FIG. 2, the client 10 comprises a variety of components including application software 20, system software 22, device specific peripherals 24, hardware components 26 and optional external components 28. It is noted that the memory component of the hardware components 26 can take various forms, including, for example, on-board processor cache memory, RAM (with various types, such as static, dynamic, EDO . . . to implement various registers, cache, and other features), ROM, flash memory (particularly used to store BIOS routines). Electronic data stored within memory of the hardware components can be individually accessed through calls made by the operating system, as is known, and familiarity with such requests for such different types of accesses is assumed.

A rules agent 200 is installed on the client 10 and includes a software application that is initiated by the operating system 220 when the operating system is loaded or restarted. The rules agent 200 performs functions described in the co-pending applications referred to in the Cross Reference to Related Applications section of this application using combinations of known operations, such as, for example, reading and writing directly to components of the client 10, using operating system 220 service calls and reading and writing operating system 220 registries and data. Various different modules of the rules agent 200 may be embedded in different system hardware or peripheral components of the client 10, as well as being embedded with the operating system 220.

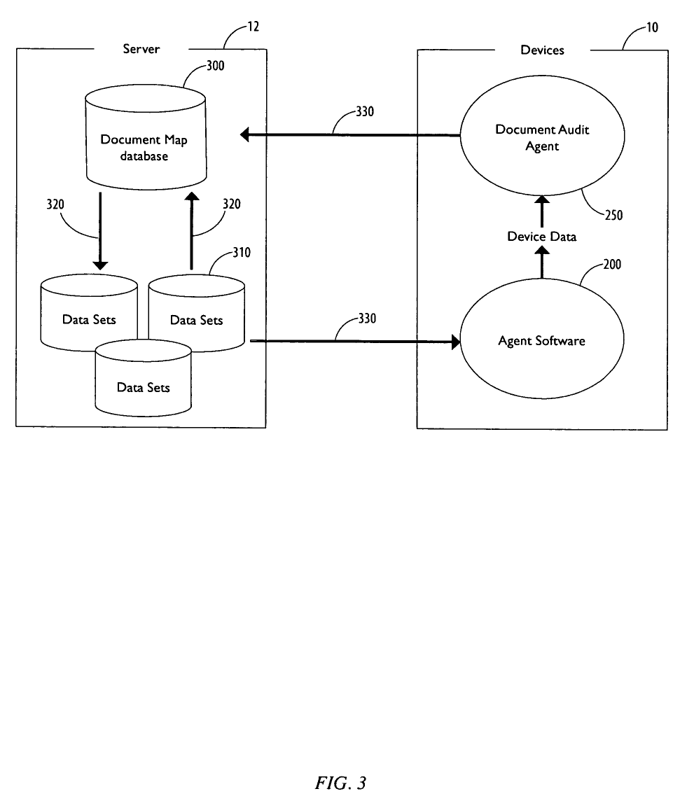

With reference to FIG. 3, the architecture of the system for providing enterprise wide data security of the invention includes a document map database 300 operatively coupled to a plurality of data sets 310 by means of adaptive processes 320. The document map database 300 and the plurality of data sets 310 reside in the server 12. The document map database 300 may include an SQL database, allowing the system administrator to perform custom analysis using Crystal Reports. The document map database 300 is populated and updated by periodic uploads from document audit agents 250 installed on clients 10.

The document audit agent 250 includes a software application that is initiated by the operating system 220 when the operating system is loaded or restarted. The document audit agent 250 is operable to periodically gather and update information related to all documents stored on the client 10. The gathered information includes document properties such as file name, type, author, location, date last modified, and size.

The information gathering process may be initiated upon the loading of the document audit agent 250 onto the client 10. As the initial information gathering process may be substantial and require substantial amounts of time and processor resources, the process may be deferred until a point after the loading of the document audit agent 250. Subsequent information gathering processes updating document information may not require substantial time and resources as most users do not create large numbers of new documents, but rather, receive new documents by email or via the web.

The document audit agent 250 is further operable to generate a document catalog for each client 10. The document catalog may include the gathered and updated information of all documents of interest residing on the client 10. Documents of interest may include pre-filtered and post-filtered documents. The document catalog further includes information sufficient to allow the system administrator to distinguish a document from other documents. The document catalog also includes meta data.

The document catalog is communicated to the central controller server 12 periodically over a communications link 330 during a client device check in procedure. The document catalogs received from clients 10 are aggregated in the document map database 300 to provide the system administrator with a visual document map across all clients 10 which depicts the documents residing on clients 10. The document map uses file directory paths but these are hidden from the system administrator enabling the system administrator to focus on document auditing.

Based upon the document map, the system administrator may create the data sets 310. Data sets 310 are used by the system administrator to package documents and document information into manageable groups. Data sets 310 may include groupings of documents having shared parameters such as file type and file extension, groupings of documents having shared date-based properties, or groupings of documents having a shared risk.

Security rules specific to particular data sets 310 may be associated with each data set 310, executed by the rules agent 200, and may be triggered by one or more triggers including invalid login attempts and detection that the client 10 has been lost or stolen. Data sets 310 enable system administrators to tailor data destruction actions to the particular nature of documents in each data set 310.

Data sets 310 are adaptive and automatically adapt to changes in the document map by means of the adaptive processes 320. As users add, update and remove files from clients 10, these changes are reflected in the document map and, in turn, in the data sets 310 including the added, updated and removed files. Adaptive processes 320 rely on a real-time view of the enterprise and this is ensured by periodic client check in procedures and an alert communication procedure that ensures that any document map database 300 updates are delivered during device 10 network connections.

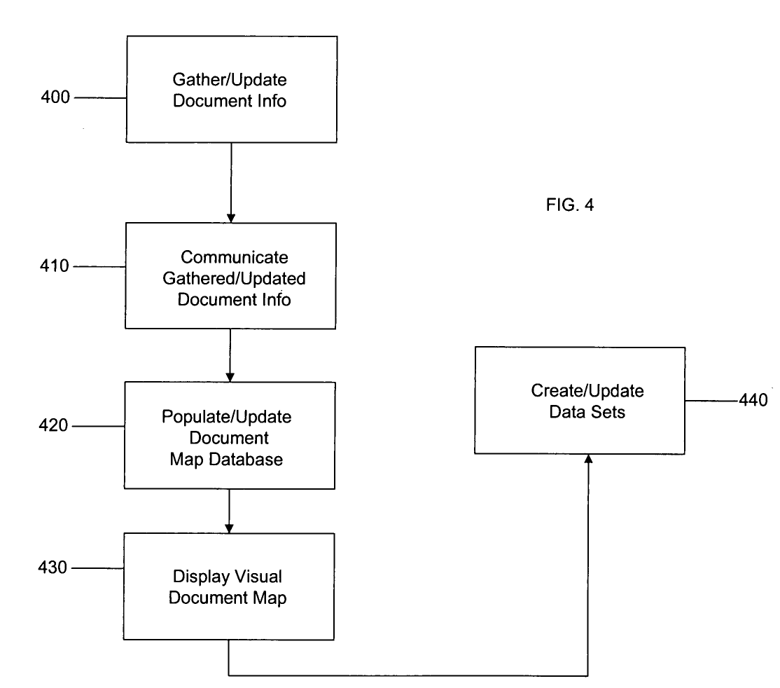

A method in accordance with the invention includes steps operable to provide enterprise wide security to a plurality of client machines 10 as described herein. With reference to FIG. 4, in a step 400 document information is gathered and updated in each of the plurality of client machines 10 by document audit agents 250. The gathered/updated information includes document properties such as file name, type, author, location, date last modified, and size. The gathered/updated information is then communicated to the server machine 12 in a step 410. The gathered/updated information may be in the form of a document catalog. In a step 420 the server machine 12 populates/updates the document map database 300 with the gathered/updated information received from the client machines 10. The visual document map is displayed in a step 430 to provide the system administrator with a visual display of all of the documents across all of the client machines 10. Based upon the visual document map, the system administrator creates and updates the data sets 310 in a step 440. Data sets 310 are used by the system administrator to package documents and document information into manageable groups. Data sets 310 may have security rules associated therewith. Security rules may be triggered by one or more triggers and executed by rules agents 200 as previously described.

The method in accordance with the present invention may include a computer-implementable method. Embodiments may be implemented in hardware, software, firmware, middleware, microcode, hardware description languages, or any combination thereof. When implemented in software, firmware, middleware or microcode, the program code or code segments to perform the necessary method steps may be stored in a machine readable medium such as storage medium. One or more processors may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, and data may be passed, forwarded, or transmitted via any suitable means including memory sharing, message passing, token passing, and network transmission

The system and method of the present invention provides for improved data security capabilities including lost data destruction capabilities. The document map represents a unique view of the contents of a mobile enterprise. The document map further provides system administrators with a means of interacting with the content of the mobile enterprise rather than with the end point computing devices. This is enabled by the document map database 300 which has updated, real-time information about all files on all devices 10 across the enterprise.

It is apparent that the above embodiments may be altered in many ways without departing from the scope of the invention. For example, the client may be a PDA, a server, a network router or other computing device and the operating system may be any commercially available or proprietary operating system. Further, various aspects of a particular embodiment may contain patentably subject matter without regard to other aspects of the same embodiment. Still further, various aspects of different embodiments can be combined together. Accordingly, the scope of the invention should be determined by the following claims and their legal equivalents.

What is claimed is:

1. A system for providing enterprise wide data security comprising:
a server machine having a document map database coupled to a plurality of data sets; and
at least one client machine coupled to the server machine, the at least one client machine having stored thereon data to be secured, the at least one client machine comprising a rules agent and a document audit agent.

2. The system of claim 1, wherein the document map database stores a document catalog provided by the document audit agent.

3. The system of claim 2, wherein the document catalog includes gathered and updated information of all documents of interest residing on the at least one client machine and representing the stored data.

4. The system of claim 3, wherein the documents of interest comprise pre-filtered documents.

5. The system of claim 3, wherein the documents of interest comprise post-filtered documents.

6. The system of claim 1, further comprising a visual document map based upon the document map database, the visual document map providing knowledge of all documents residing on the at least one client machine.

7. The system of claim 6, wherein the visual document map is used to define each of the data sets, each of the data sets being groupings of documents targeted for destruction in the event of loss or theft of the at least one client machine.

8. The system of claim 1, wherein the rules agent is operable to execute security rules associated with each of the plurality of data sets.

9. The system of claim 1, wherein each of the plurality of data sets comprise groupings of documents having shared parameters.

10. The system of claim 1, wherein each of the data sets is adaptively coupled to the document map database such that changes in the document map database are reflected in each of the data sets affected by such changes.

11. A system of securing data stored on a plurality of portable electronic devices comprising:
a server machine coupled to each of the plurality of portable electronic devices, the server machine comprising a plurality of data sets adaptively coupled to a document map database, the document map database storing a document catalog provided by a document audit agent residing on each of the portable electronic devices, each of the portable electronic devices further comprising a rules agent operable to execute security rules associated with each of the plurality of data sets.

12. The system of claim 11, wherein the document catalog includes gathered and updated information of all documents of interest for each of the portable electronic devices.

13. The system of claim 11, further comprising a visual document map based upon the document map database, the visual document map providing knowledge of all documents residing on each of the portable electronic devices.

14. The system of claim 13, wherein the visual document map is used to define each of the data sets, each of the data sets being groupings of documents having associated security rules.

15. The system of claim 11, wherein each of the plurality of data sets comprise groupings of documents having shared parameters.

16. The system of claim 11, wherein changes in the document map database reflect changes in the document catalogs communicated to the server machine by each of the portable electronic device during a periodic device check in procedure.

17. The system of claim 11, wherein changes in the document map database are reflected in each of the data sets affected by such changes.

18. The system of claim 11, wherein the document catalog comprises information sufficient to allow a system administrator to distinguish a first document from a second document.

19. The system of claim 11, wherein the document catalog comprises meta data.

20. A method of securing data stored on a plurality of client machines comprising the steps of:
gathering and updating document information in each of the plurality of client machines;
communicating the document information to a server machine;
populating and updating a document map database in the server machine;
displaying a visual document map on the server machine; and
creating and updating a plurality of data sets based upon the visual document map, the plurality of data sets having associated therewith security rules for securing the data stored on the plurality of client machines.
